(19) United States
(12) Patent Application Publication
(10) Pub. No.: US 2016/0296407 A1
(43) Pub. Date: Oct. 13, 2016

(54) STRUCTURAL FRAME TO ASSIST PATIENTS AND METHODS OF USE THEREOF

(71) Applicant: Elwha LLC, Bellevue, WA (US)

(72) Inventors: Mahalaxmi Gita Bangera, Renton, WA (US); Jesse R. Cheatham, III, Seattle, WA (US); Hon Wah Chin, Palo Alto, CA (US); Roderick A. Hyde, Redmond, WA (US); Muriel Y. Ishikawa, Livermore, CA (US); Jordin T. Kare, San Jose, CA (US); Eric C. Leuthardt, St. Louis, MO (US); Robert W. Lord, Seattle, WA (US); Richard T. Lord, Gig Harbor, WA (US); Robert C. Petroski, Seattle, WA (US); Clarence T. Tegreene, Mercer Island, WA (US); Lowell L. Wood, Jr., Bellevue, WA (US)

(21) Appl. No.: 14/684,853

(22) Filed: Apr. 13, 2015

(51) Int. Cl. A61H 3/00; A45B 9/00

(52) U.S. Cl. CPC A61H 3/00; A45B 9/00; A61H 2201/0173

(57) ABSTRACT

A structural frame and methods of use thereof are disclosed that assists a patient that has limited ambulation. A structural frame is disclosed that includes a linear rod having a first end and a second end; two or more expandable telescoping sections disposed between the first end and the second end of the linear rod wherein the two or more expandable telescoping sections are operable to expand the linear rod bidirectionally at the first end and the second end; a force-loading mechanism engaging each of the two or more expandable telescoping sections operably connected to expand the telescoping linear rod.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### Priority Applications:

None.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

A structural frame and methods of use thereof are disclosed that assist a patient that has limited ambulation. A structural frame is disclosed that assists a patient in walking, standing, or movement on uneven ground, onto stairs, or through obstructions. The structural frame may include a walker, a crutch, or a cane. A structural frame is disclosed that includes a linear rod having a first end and a second end; two or more expandable telescoping sections disposed between the first end and the second end of the linear rod wherein the two or more expandable telescoping sections are operable to expand the linear rod bidirectionally at the first end and the second end; a force-loading mechanism engaging each of the two or more expandable telescoping sections operably connected to expand the telescoping linear rod and operably connected to apply outward compressive force at each of the first end and the second end; and one or more extendable and retractable load-bearing feet at at least one of the first end and the second end of the linear rod, wherein the one or more load-bearing feet are operable to extend from a stowed position to a load-bearing position for engagement with an exterior surface and to retract to the stowed position. The force-loading mechanism may include one or more of a spring loading mechanism, a hydraulic loading mechanism, or a motor. The force-loading mechanism may be configured to be manually applied by user. The structural frame may include a locking mechanism, wherein the two or more expandable telescoping sections of the linear rod are configured to be secured into place by the locking mechanism during application of the outward compressive force. In some aspects, the extendable and retractable load-bearing feet are configured to be repositioned between the stowed and the load-bearing positions. In some aspects, the extendable and retractable load-bearing feet are configured to be linearly extended into place or rotationally flipped into place. The extendable and retractable load-bearing feet may be configured to mate with one or more pre-placed receptacles in a floor or wall. The second end may include one or more fixed load-bearing feet configured to contact the floor and one or more of the extendable and retractable load-bearing feet. The first end may include a fixed hand grasp handle and one or more of the extendable and retractable load-bearing feet.

The structural frame may include a sensor in communication with a controller to determine a size of an opening span in a vicinity of the structural frame and to control extension of the two or more expandable telescoping sections to the size of the opening span. In some aspects, the structural frame may include a sensor in communication with a controller to determine a presence of an opening span in a vicinity of the structural frame and to control extension of at least one of the load-bearing feet. In some aspects, the controller may be configured to control the extension based on proximity of an end of the linear rod to a surface of the opening span. The controller may be configured to control the extension based on an orientation of the linear rod relative to the opening span. The structural frame may include a sensor in communication with a controller to determine a loss of contact of at least one of the load-bearing feet with a surface and to control retraction of the load-bearing feet. The structural frame may include a sensor in communication with a controller to monitor lateral load bearing or slippage and to increase anchor force of the linear rod in response to the lateral load bearing or the slippage. The structural frame may be configured to increase the anchor force by increasing suction at the extendable and retractable load-bearing feet. The structural frame may be configured to increase the anchor force by driving a spike from the extendable and retractable load-bearing feet into a wall. The structural frame may be configured to increase the anchor force by increasing the outward compressive force. The structural frame may include a pump attached to the structural frame, wherein the pump is configured to increase the anchor force by increasing suction at the extendable and retractable load-bearing feet. The structural frame may include a gecko microsuction force surface integrated at the extendable and retractable load-bearing feet, wherein the structural frame is configured to increase the anchor force by increasing gecko microsuction force at the extendable and retractable load-bearing feet.

A method for engaging a structural frame is disclosed that includes expanding a linear rod bidirectionally at a first end and a second end, the linear rod having two or more expandable telescoping sections disposed between the first end and the second end; engaging each of the two or more expandable telescoping sections operably connected to a force-loading mechanism, the force-loading mechanism operable to expand the telescoping linear rod and operable to apply outward compressive force at each of the first end and the second end; and extending one or more extendable and retractable load-bearing feet at at least one of the first end and the second end of the linear rod, wherein the one or more load-bearing feet are operable to extend from a stowed position to a load-bearing position for engagement with an exterior surface and to retract to the stowed position. The method may include securing the two or more expandable telescoping sections of the linear rod into place by a locking mechanism during application of the outward compressive force. The method may include repositioning the extendable and retractable load-bearing feet between the stowed and the load-bearing positions. The method may include linearly extending or rotationally flipping the extendable and retractable load-bearing feet into place. The method may include contacting the floor with one or more fixed load-bearing feet at the second end and with one or more of the extendable and retractable load-bearing feet. The method may include mating the extendable and retractable load-bearing feet with one or more pre-placed receptacles in a floor or wall.

The method may include determining with a sensor in communication with a controller a size of an opening span in a vicinity of the structural frame and controlling extension of the two or more expandable telescoping sections to the size of the opening span. The method may include determining with a sensor in communication with a controller a presence of an opening span in a vicinity of the structural frame and controlling extension of at least one of the load-bearing feet. The method may also include controlling the extension based on proximity of an end of the linear rod to a surface of the opening span. The method may also include controlling the extension based on an orientation of the linear rod relative to the opening span. The method may include determining with a sensor in communication with a controller a loss of contact of at least one of the load-bearing feet with a surface and controlling retraction of the load-bearing feet. The method may include monitoring with a sensor in communication with a controller a lateral load bearing or slippage and increasing anchor force of the linear rod in response to the lateral load bearing or the slippage. The may include increasing the anchor force by increasing suction at the extendable and retractable load-bearing feet. The method may include increasing the anchor force by driving a spike from the extendable and retractable load-bearing feet into a wall. The method may include increasing the anchor force by increasing the outward compressive force. The method may include increasing the anchor force by increasing suction at the extendable and retractable load-bearing feet with a pump attached to the structural frame. The method may include increasing the anchor force by increasing gecko microsuction force at the extendable and retractable load-bearing feet with a gecko microsuction force surface integrated at the extendable and retractable load-bearing feet.

A method of producing a structural frame is disclosed that includes providing a linear rod having a first end and a second end; two or more expandable telescoping sections disposed between the first end and the second end of the linear rod wherein the two or more expandable telescoping sections are operable to expand the linear rod bidirectionally at the first end and the second end; a force-loading mechanism engaging each of the two or more expandable telescoping sections operably connected to expand the telescoping linear rod and operably connected to apply outward compressive force at each of the first end and the second end; and one or more extendable and retractable load-bearing feet at at least one of the first end and the second end of the linear rod, wherein the one or more load-bearing feet are operable to extend from a stowed position to a load-bearing position for engagement with an exterior surface and to retract to the stowed position.

A structural frame is disclosed that includes a walker having two or more substantially vertically extending base legs and an upright support portion extending vertically upward from the base legs; one or more vertical linear portions operably attached to the walker and substantially parallel to the base legs, each of the one or more vertical linear portions having a first end and a second end; one or more horizontal linear portions operably attached to the walker and substantially perpendicular to the base legs, the one or more horizontal linear portions enclosing one or more first expandable telescoping sections disposed within the horizontal linear portions, wherein each of the one or more horizontal linear portions have a third end and a fourth end; and a force loading mechanism engaging each of the one or more of the first expandable telescoping sections, wherein the force loading mechanism is operably connected to expand the one or more of the first expandable telescoping sections and is operably connected to apply outward compressive force at each of the third end and the fourth end. In some aspects, the one or more vertical linear portions enclose one or more second expandable telescoping sections disposed within the vertical linear portions. The structural frame may include extendable and retractable load-bearing feet at the first end and the second end of the vertical linear portion and at the third end and the fourth end of the horizontal linear portion, wherein the load-bearing feet are operable to extend upon expansion of the one or more first expandable telescoping sections and the one or more second expandable telescoping sections. In some aspects, the one or more vertical poles may have the force loading mechanism operably connected to expand the second expandable telescoping sections of the vertical poles in the vertical direction and the one or more horizontal poles have the force loading mechanism may be operably connected to expand the first expandable telescoping sections of the horizontal poles in the horizontal direction. The one or more vertical poles have the force loading mechanism may be operably connected to expand the second expandable telescoping sections of the vertical poles inclined from the vertical direction and the one or more horizontal poles have the force loading mechanism operably connected to expand the first expandable telescoping sections of the horizontal poles inclined from the horizontal direction. The force-loading mechanism may include one or more of a spring loading mechanism, a hydraulic loading mechanism, or a motor. The force-loading mechanism may be configured to be manually applied by user. The structural frame may include a locking mechanism, wherein the two or more expandable telescoping sections of the linear rod are configured to be secured into place by the locking mechanism during application of the outward compressive force. The one or more horizontal linear portions may enclose one first expandable telescoping sections is disposed within the horizontal linear portions, and expandable in one dimension. The one or more horizontal linear portions may enclose two first expandable telescoping sections is disposed within the horizontal linear portions, and expandable in two dimensions.

The structural frame may include a sensor in communication with a controller to determine a size of an opening span in a vicinity of the structural frame and to control extension of the one or more expandable telescoping sections to the size of the opening span. The structural frame may include a sensor in communication with a controller to determine a presence of an opening span in a vicinity of the structural frame and to control extension of at least one of the load-bearing feet. In some aspects, the controller may be configured to control the extension based on proximity of an end of the linear portion to a surface of the opening span. The controller may be configured to control the extension based on an orientation of the linear portion relative to the opening span. The structural frame may include a sensor in communication with a controller to determine a loss of contact of at least one of the load-bearing feet with a surface and to control retraction of the load-bearing feet. The structural frame may include a sensor in communication with a controller to monitor lateral load bearing or slippage and to increase anchor force of the linear portion in response to the lateral load bearing or the slippage. In some aspects, the structural frame may be configured to increase the anchor force by increasing suction at the extendable and retractable load-bearing feet. The structural frame may be configured to increase the anchor force by driving a spike from the extendable and retractable load-bearing feet into an exterior surface. The structural frame may be configured to increase the anchor force by increasing the outward compressive force. The structural frame may include a pump attached to the structural frame, wherein the pump is configured to increase the anchor force by increasing suction at the extendable and retractable load-bearing feet. The structural frame may include a gecko microsuction force surface integrated at the extendable and retractable load-bearing feet, wherein the structural frame is configured to increase the anchor force by increasing gecko microsuction force at the extendable and retractable load-bearing feet.

A method for engaging a structural frame is disclosed that includes expanding one or more first expandable telescoping sections disposed within one or more horizontal linear portions operably attached to a walker having two or more substantially vertically extending base legs and an upright support portion extending vertically upward from the base legs, wherein the one or more horizontal linear portions are substantially perpendicular to the base legs, and wherein each of the one or more horizontal linear portions have a first end and a second end; and engaging each of the one or more first expandable telescoping sections with a force-loading mechanism, wherein the force-loading mechanism is operable to expand the one or more first expandable telescoping sections and is operable to apply outward compressive force at each of the first end and the second end. The method may include expanding one or more second expandable telescoping sections disposed within one or more vertical linear portions operably attached to a walker and substantially parallel to the base legs, each of the one or more vertical linear portions having a third end and a fourth end. The method may also include extending one or more extendable and retractable load-bearing feet at at least one of the first end and the second end of the vertical linear portion and extending the one or more extendable and retractable load-bearing feet at at least one of the third end and the fourth end of the horizontal linear portion, wherein the one or more load-bearing feet are operable to extend from a stowed position to a load-bearing position for engagement with an exterior surface and to retract to the stowed position. The method may include operably connecting the force loading mechanism to the one or more horizontal poles to expand the first expandable telescoping sections of the horizontal poles in the horizontal direction; and operably connecting the force loading mechanism to the one or more vertical poles to expand the second expandable telescoping sections of the vertical poles in the vertical direction. The method may also include operably connecting the force loading mechanism to the one or more horizontal poles to expand the first expandable telescoping sections of the horizontal poles inclined from the horizontal direction; and operably connecting the force loading mechanism to the one or more vertical poles to expand the second expandable telescoping sections of the vertical poles inclined from the vertical direction. The method may include securing the first expandable telescoping sections of the one or more horizontal poles into place or the second expandable telescoping sections of the one or more vertical poles into place by a locking mechanism during application of the outward compressive force. The method may include determining with a sensor in communication with a controller a size of an opening span in a vicinity of the structural frame and controlling extension of the one or more expandable telescoping sections to the size of the opening span.

The method may include determining with a sensor in communication with a controller a presence of an opening span in a vicinity of the structural frame and controlling extension of at least one of the load-bearing feet. The may include controlling the extension based on proximity of an end of the vertical linear portion or the horizontal linear portion to a surface of the opening span. The method may include controlling the extension based on an orientation of the vertical linear portion or the horizontal linear portion relative to the opening span. The method may include determining with a sensor in communication with a controller a loss of contact of at least one of the load-bearing feet with a surface and controlling retraction of the load-bearing feet. The method may include monitoring with a sensor in communication with a controller lateral load bearing or slippage and increasing anchor force of the vertical linear portion or the horizontal linear portion in response to the lateral load bearing or the slippage. The method may include increasing the anchor force by driving a spike from the extendable and retractable load-bearing feet into an exterior surface. The method may include increasing the anchor force by increasing the outward compressive force. The method may include increasing the anchor force by increasing suction at the extendable and retractable load-bearing feet with a pump attached to the structural frame. The method may include increasing the anchor force by increasing suction at the extendable and retractable load-bearing feet. The method may include also increasing the anchor force by increasing gecko microsuction force at the extendable and retractable load-bearing feet with a gecko microsuction force surface integrated at the extendable and retractable load-bearing feet.

A method of producing a structural frame is disclosed that includes providing a walker having two or more substantially vertically extending base legs and an upright support portion extending vertically upward from the base legs; one or more vertical linear portions operably attached to the walker and substantially parallel to the base legs, each of the one or more vertical linear portions having a first end and a second end; one or more horizontal linear portions operably attached to the walker and substantially perpendicular to the base legs, the one or more horizontal linear portions enclosing one or more first expandable telescoping sections disposed within the horizontal linear portions, wherein each of the one or more horizontal linear portions have a third end and a fourth end; and a force loading mechanism engaging each of the one or more of the first expandable telescoping sections, wherein the force loading mechanism is operably connected to expand the one or more of the first expandable telescoping sections and is operably connected to apply outward compressive force at each of the third end and the fourth end.

A structural frame is disclosed that includes a linear rod having a first end and a second end; load-bearing feet attached at one of the first end and the second end of the linear rod; and a controllable force-application mechanism operably connected to the load-bearing feet, the controllable force-application mechanism configured to activate the load-bearing feet to facilitate secure and reversible attachment of the load-bearing feet to a horizontal or vertical surface of a structure proximal to the first end or the second end of the linear rod, and the controllable force-application mechanism configured to activate the load-bearing feet to facilitate secure and reversible disconnection of the load-bearing feet from the horizontal or vertical surface substantially parallel to an axis of the linear rod. The structural frame may include a pump attached to the structural frame, wherein the controllable force-application mechanism is configured to increase an attachment force by increasing suction at the load-bearing feet. The structural frame may also include a gecko microsuction force surface integrated at the load-bearing feet, wherein the controllable force-application mechanism is configured to increase an attachment force by increasing contact of the gecko microsuction force surface with the horizontal or vertical surface of the proximal structure. The controllable force-application mechanism may be configured to increase contact of the gecko microsuction force surface by changing a location of the gecko microsuction force surface within the load-bearing feet. The structural frame may include a hook and loop type fastener surface integrated at the load-bearing feet, wherein the controllable force-application mechanism is configured to increase an attachment force by increasing contact of the hook and loop type fastener surface with the horizontal or vertical surface of the proximal structure. The controllable force-application mechanism may be configured to increase contact of the hook and loop type fastener surface by changing the location of the hook and loop type fastener surface within the load-bearing feet. The structural frame may include an extendable and retractable handle grip attached at least one of the first end and the second end of the linear rod. In some aspects, the linear rod may be separable into two or more segments to form a V-shaped structure or a U-shaped structure having load-bearing feet attached at the first end and the second end of the linear rod.

The structural frame may include a sensor in communication with a controller to monitor lateral load bearing or slippage and to increase an attachment force of the linear rod in response to the lateral load bearing or the slippage. The controllable force-application mechanism may be configured to increase the attachment force by increasing suction at the extendable and retractable load-bearing feet. The controllable force-application mechanism may be configured to increase the attachment force by driving a spike from the extendable and retractable load-bearing feet into an exterior surface.

A method for engaging a structural frame is disclosed that includes activating load-bearing feet attached at one of a first end and a second end of a linear rod with a controllable force-application mechanism operably connected to the load-bearing feet; facilitating with the force-application mechanism secure and reversible attachment of the activated load-bearing feet to a horizontal or vertical surface of a structure proximal to the first end or the second end of the linear rod; and activating the load-bearing feet with the controllable force-application mechanism to facilitate secure and reversible disconnection of the load-bearing feet from the horizontal or vertical surface substantially parallel to an axis of the linear rod. The method may include increasing an attachment force by increasing suction at the load-bearing feet with a pump as the controllable force-application mechanism attached to the structural frame. The method may also include increasing an attachment force by increasing gecko microsuction force at the load-bearing feet with a gecko microsuction force surface integrated at the load-bearing feet, wherein the controllable force-application mechanism is configured to increase the attachment force by increasing contact of the gecko microsuction force surface with the horizontal or vertical surface of the proximal structure. The method may include increasing contact of the gecko microsuction force surface by changing with the controllable force-application mechanism a location of the gecko microsuction force surface on the load-bearing feet. The method may include integrating a hook and loop type fastener surface at the load-bearing feet, wherein the controllable force-application mechanism is configured to increase an attachment force by increasing contact of the hook and loop type fastener surface with the horizontal or vertical surface of the proximal structure. The method may include increasing the attachment force by increasing contact of the hook and loop type fastener surface with the controllable force-application mechanism and by changing the location of the hook and loop type fastener surface within the load-bearing feet. The method may include separating the linear rod into two or more segments to form a V-shaped structure or a U-shaped structure having load-bearing feet attached at the first end and the second end of the linear rod.

The method may include monitoring with a sensor in communication with a controller lateral load bearing or slippage and to increase an attachment force of the linear rod in response to the lateral load bearing or the slippage. The method may include increasing an attachment force by increasing with the controllable force-application mechanism suction at the extendable and retractable load-bearing feet. The method may include increasing an attachment force by increasing with the controllable force-application mechanism a driving force of a spike from the extendable and retractable load-bearing feet into an exterior surface.

A method of producing a structural frame is disclosed that includes providing a linear rod having a first end and a second end; load-bearing feet attached at one of the first end and the second end of the linear rod; and a controllable force-application mechanism operably connected to the load-bearing feet, the controllable force-application mechanism configured to activate the load-bearing feet to facilitate secure and reversible attachment of the load-bearing feet to a horizontal or vertical surface of a structure proximal to the first end or the second end of the linear rod, and the controllable force-application mechanism configured to activate the load-bearing feet to facilitate secure and reversible disconnection of the load-bearing feet from the horizontal or vertical surface substantially parallel to an axis of the linear rod.

### BRIEF DESCRIPTION OF THE FIGURES

FIG. 1 depicts a diagrammatic view of an aspect of a structural frame.

FIG. 2 depicts a diagrammatic view of an aspect of a structural frame.

FIG. 3 depicts a diagrammatic view of an aspect of a structural frame.

FIG. 4 depicts a diagrammatic view of an aspect of a structural frame.

FIG. 5 depicts a diagrammatic view of an aspect of a structural frame.

FIG. 6 depicts a diagrammatic view of an aspect of a structural frame.

FIG. 7 depicts a diagrammatic view of an aspect of a structural frame.

FIG. 8 depicts a diagrammatic view of an aspect of a structural frame.

FIG. 9 depicts a diagrammatic view of an aspect of a method for engaging a structural frame.

FIG. 10 depicts a diagrammatic view of an aspect of a method for engaging a structural frame.

FIG. 11 depicts a diagrammatic view of an aspect of a method for engaging a structural frame.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A structural frame and methods of use thereof are disclosed that assist a patient that has limited ambulation. A structural frame is disclosed that assists a patient in walking, standing, or movement on uneven ground, onto stairs, or through obstructions. The structural frame may include a walker, a crutch, or a cane. A structural frame is disclosed that includes a linear rod having a first end and a second end; two or more expandable telescoping sections disposed between the first end and the second end of the linear rod wherein the two or more expandable telescoping sections are operable to expand the linear rod bidirectionally at the first end and the second end; a force-loading mechanism engaging each of the two or more expandable telescoping sections operably connected to expand the telescoping linear rod and operably connected to apply outward compressive force at each of the first end and the second end; and one or more extendable and retractable load-bearing feet at at least one of the first end and the second end of the linear rod, wherein the one or more load-bearing feet are operable to extend from a stowed position to a load-bearing position for engagement with an exterior surface and to retract to the stowed position.

A method for engaging a structural frame is disclosed that includes expanding a linear rod bidirectionally at a first end and a second end, the linear rod having two or more expandable telescoping sections disposed between the first end and the second end; engaging each of the two or more expandable telescoping sections operably connected to a force-loading mechanism, the force-loading mechanism operable to expand the telescoping linear rod and operable to apply outward compressive force at each of the first end and the second end; and extending one or more extendable and retractable load-bearing feet at at least one of the first end and the second end of the linear rod, wherein the one or more load-bearing feet are operable to extend from a stowed position to a load-bearing position for engagement with an exterior surface and to retract to the stowed position.

A method of producing a structural frame is disclosed that includes providing a linear rod having a first end and a second end; two or more expandable telescoping sections disposed between the first end and the second end of the linear rod wherein the two or more expandable telescoping sections are operable to expand the linear rod bidirectionally at the first end and the second end; a force-loading mechanism engaging each of the two or more expandable telescoping sections operably connected to expand the telescoping linear rod and operably connected to apply outward compressive force at each of the first end and the second end; and one or more extendable and retractable load-bearing feet at at least one of the first end and the second end of the linear rod, wherein the one or more load-bearing feet are operable to extend from a stowed position to a load-bearing position for engagement with an exterior surface and to retract to the stowed position.

A structural frame is disclosed that includes a walker having two or more substantially vertically extending base legs and an upright support portion extending vertically upward from the base legs; one or more vertical linear portions operably attached to the walker and substantially parallel to the base legs, each of the one or more vertical linear portions having a first end and a second end; one or more horizontal linear portions operably attached to the walker and substantially perpendicular to the base legs, the one or more horizontal linear portions enclosing one or more first expandable telescoping sections disposed within the horizontal linear portions, wherein each of the one or more horizontal linear portions have a third end and a fourth end; and a force loading mechanism engaging each of the one or more of the first expandable telescoping sections, wherein the force loading mechanism is operably connected to expand the one or more of the first expandable telescoping sections and is operably connected to apply outward compressive force at each of the third end and the fourth end.

A method for engaging a structural frame is disclosed that includes expanding one or more first expandable telescoping sections disposed within one or more horizontal linear portions operably attached to a walker having two or more substantially vertically extending base legs and an upright support portion extending vertically upward from the base legs, wherein the one or more horizontal linear portions are substantially perpendicular to the base legs, and wherein each of the one or more horizontal linear portions have a first end and a second end; and engaging each of the one or more first expandable telescoping sections with a force-loading mechanism, wherein the force-loading mechanism is operable to expand the one or more first expandable telescoping sections and is operable to apply outward compressive force at each of the first end and the second end.

A method of producing a structural frame is disclosed that includes providing a walker having two or more substantially vertically extending base legs and an upright support portion extending vertically upward from the base legs; one or more vertical linear portions operably attached to the walker and substantially parallel to the base legs, each of the one or more vertical linear portions having a first end and a second end; one or more horizontal linear portions operably attached to the walker and substantially perpendicular to the base legs, the one or more horizontal linear portions enclosing one or more first expandable telescoping sections disposed within the horizontal linear portions, wherein each of the one or more horizontal linear portions have a third end and a fourth end; and a force loading mechanism engaging each of the one or more of the first expandable telescoping sections, wherein the force loading mechanism is operably connected to expand the one or more of the first expandable telescoping sections and is operably connected to apply outward compressive force at each of the third end and the fourth end.

A structural frame is disclosed that includes a linear rod having a first end and a second end; load-bearing feet attached at one of the first end and the second end of the linear rod; and a controllable force-application mechanism operably connected to the load-bearing feet, the controllable force-application mechanism configured to activate the load-bearing feet to facilitate secure and reversible attachment of the load-bearing feet to a horizontal or vertical surface of a structure proximal to the first end or the second end of the linear rod, and the controllable force-application mechanism configured to activate the load-bearing feet to facilitate secure and reversible disconnection of the load-bearing feet from the horizontal or vertical surface substantially parallel to an axis of the linear rod.

A method for engaging a structural frame is disclosed that includes activating load-bearing feet attached at one of a first end and a second end of a linear rod with a controllable force-application mechanism operably connected to the load-bearing feet; facilitating with the force-application mechanism secure and reversible attachment of the activated load-bearing feet to a horizontal or vertical surface of a structure proximal to the first end or the second end of the linear rod; and activating the load-bearing feet with the controllable force-application mechanism to facilitate secure and reversible disconnection of the load-bearing feet from the horizontal or vertical surface substantially parallel to an axis of the linear rod.

A method of producing a structural frame is disclosed that includes providing a linear rod having a first end and a second end; load-bearing feet attached at one of the first end and the second end of the linear rod; and a controllable force-application mechanism operably connected to the load-bearing feet, the controllable force-application mechanism configured to activate the load-bearing feet to facilitate secure and reversible attachment of the load-bearing feet to a horizontal or vertical surface of a structure proximal to the first end or the second end of the linear rod, and the controllable force-application mechanism configured to activate the load-bearing feet to facilitate secure and reversible disconnection of the load-bearing feet from the horizontal or vertical surface substantially parallel to an axis of the linear rod.

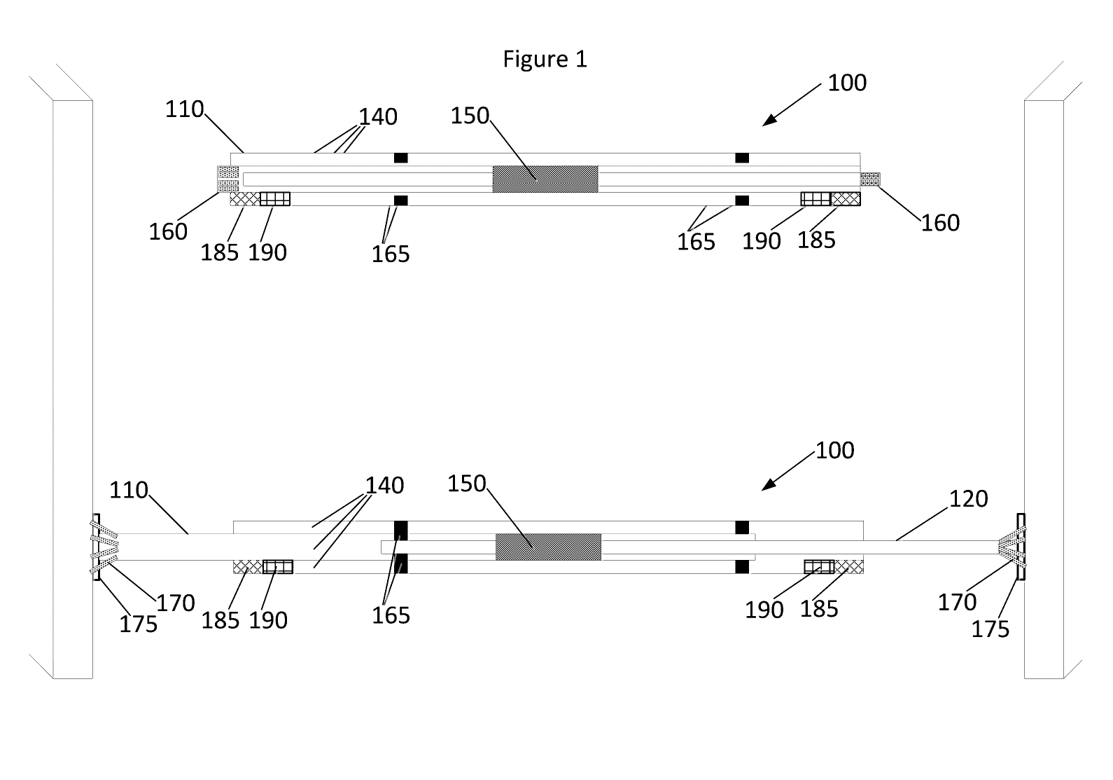

FIG. 1 shows a diagrammatic view of an aspect of a device including a structural frame. A device is provided that includes a structural frame 100 including: a linear rod 110 having a first end 120 and a second end 130; two or more expandable telescoping sections 140 disposed between the first end 120 and the second end 130 of the linear rod 110 wherein the two or more expandable telescoping sections 140 are operable to expand the linear rod bidirectionally at the first end 120 and the second end 130; and a force-loading mechanism 150 engaging each of the two or more expandable telescoping sections 140 operably connected to expand the telescoping linear rod 110 and operably connected to apply outward bidirectional compressive force at each of the first end 120 and the second end 130.

The structural frame includes extendable and retractable load-bearing feet 160 at the first end and the second end of the linear rod, wherein the load-bearing feet are operable to extend from a stowed position to a load-bearing position for engagement with an exterior surface and to retract to the stowed position. In some aspects, the force-loading mechanism 150 is a spring loading mechanism. The structural frame further includes a locking mechanism 165, wherein the expandable telescoping sections of the linear rod are configured to be secured into place by the locking mechanism during application of the outward compressive force. The second end 130 comprises of the linear rod 110 may include one or more fixed load-bearing feet 170 configured to contact the floor and one or more of the extendable and retractable load-bearing feet. In some aspects, the extendable and retractable load-bearing feet 170 are configured to mate with one or more pre-placed receptacles 175 in a floor or wall.

The structural frame 100 may include a sensor 185 in communication with a controller 190 to determine a size of an opening span in a vicinity of the structural frame and to control extension of the two or more expandable telescoping sections to the size of the opening span. The structural frame 100 may include a sensor 185 in communication with a controller 190 to monitor lateral load bearing or slippage and to increase anchor force 150 of the linear rod 110 in response to the lateral load bearing or the slippage.

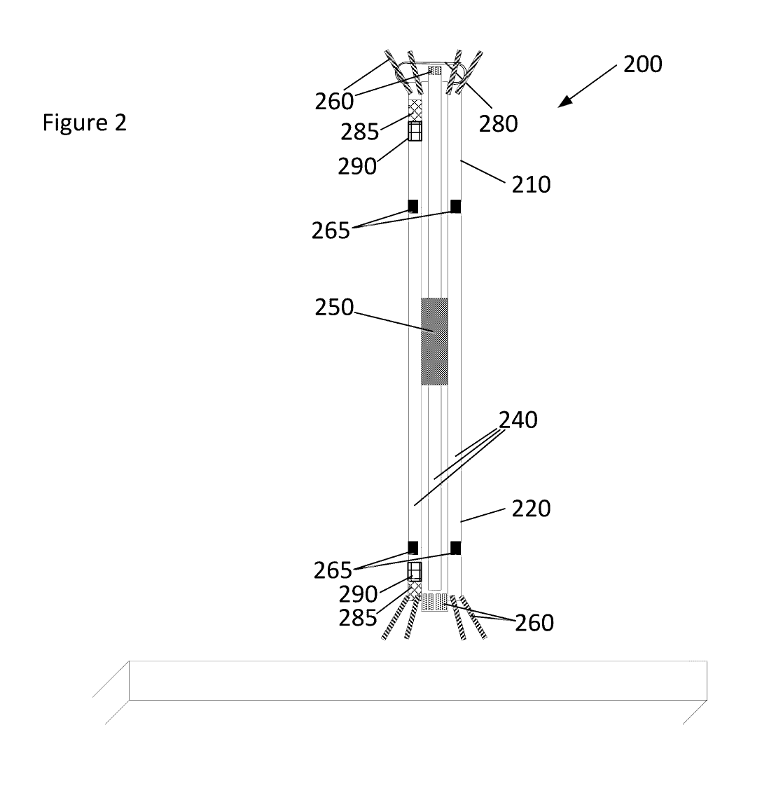

FIG. 2 shows a diagrammatic view of an aspect of a device including a structural frame. In some aspects of the structural frame 200, the first end 210 includes a fixed hand grasp handle 280 and one or more of the extendable and retractable load-bearing feet 260. The device includes a structural frame 200 including: a linear rod 210 having a first end 220 and a second end 230; two or more expandable telescoping sections 240 disposed between the first end 220 and the second end 230 of the linear rod 210 wherein the two or more expandable telescoping sections 240 are operable to expand the linear rod bidirectionally at the first end 220 and the second end 230; and a force-loading mechanism 250 engaging each of the two or more expandable telescoping sections 240 operably connected to expand the telescoping linear rod 210 and operably connected to apply outward bidirectional compressive force at each of the first end 220 and the second end 230. The structural frame includes extendable and retractable load-bearing feet 260 at the first end and the second end of the linear rod, wherein the load-bearing feet are operable to extend from a stowed position to a load-bearing position for engagement with an exterior surface and to retract to the stowed position. In some aspects, the force-loading mechanism 250 is a spring loading mechanism. The structural frame further includes a locking mechanism 265, wherein the expandable telescoping sections of the linear rod are configured to be secured into place by the locking mechanism during application of the outward compressive force. The second end 230 comprises of the linear rod 210 may include one or more fixed load-bearing feet 270 configured to contact the floor and one or more of the extendable and retractable load-bearing feet. The structural frame 200 may include a sensor 285 in communication with a controller 290 to determine a size of an opening span in a vicinity of the structural frame and to control extension of the two or more expandable telescoping sections to the size of the opening span.

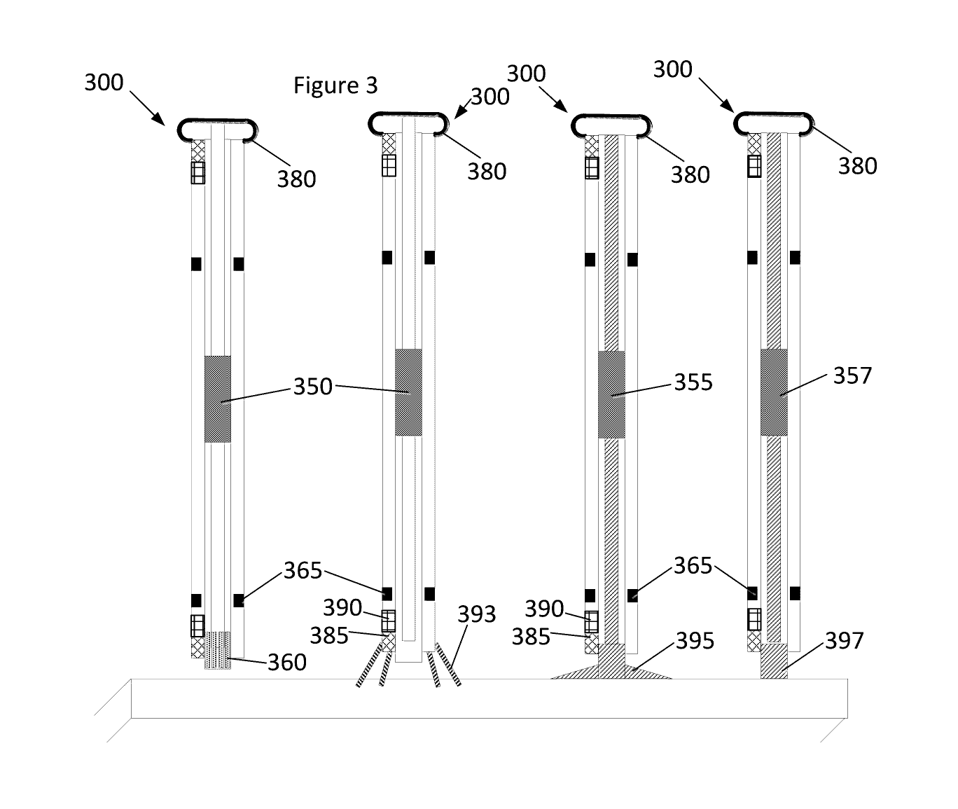

FIG. 3 shows a diagrammatic view of an aspect of a device including a structural frame. In some aspects of the structural frame 300, a sensor 385 in communication with a controller 390 to monitor lateral load bearing or slippage and to increase anchor force 350 of the linear rod in response to the lateral load bearing or the slippage. In some aspects, the structural frame 300 may be configured to increase the anchor force 350 by increasing suction at the extendable and retractable load-bearing feet 360, 395. The structural frame 300 may be configured to increase the anchor force by driving a spike 393 from the extendable and retractable load-bearing feet 360 into a wall. The structural frame 300 may include a pump 355 attached to the structural frame, wherein the pump is configured to increase the anchor force by increasing suction at the extendable and retractable load-bearing feet 395. In some aspects, the structural frame 300 may include a gecko microsuction force surface 357, 397 integrated at the extendable and retractable load-bearing feet 397, wherein the structural frame is configured to increase the anchor force by increasing gecko microsuction force at the extendable and retractable load-bearing feet 397. The extendable and retractable load-bearing feet 360 may be configured to be repositioned 360, 393. In some aspects, extendable and retractable load-bearing feet 360 are configured to be extended into place or flipped into place 360, 393.

As shown in FIG. 3, the structural frame may include a gecko microsuction force surface 397 integrated at the load-bearing feet 360, wherein the controllable force-application mechanism 357 is configured to increase an attachment force by increasing contact of the gecko microsuction force surface 397 with the horizontal or vertical surface of the proximal structure. The structural may include a hook and loop type fastener surface 397 integrated at the load-bearing feet 360, wherein the controllable force-application mechanism 357 is configured to increase an attachment force by increasing contact of the hook and loop type fastener 397 with the horizontal or vertical surface of the proximal structure.

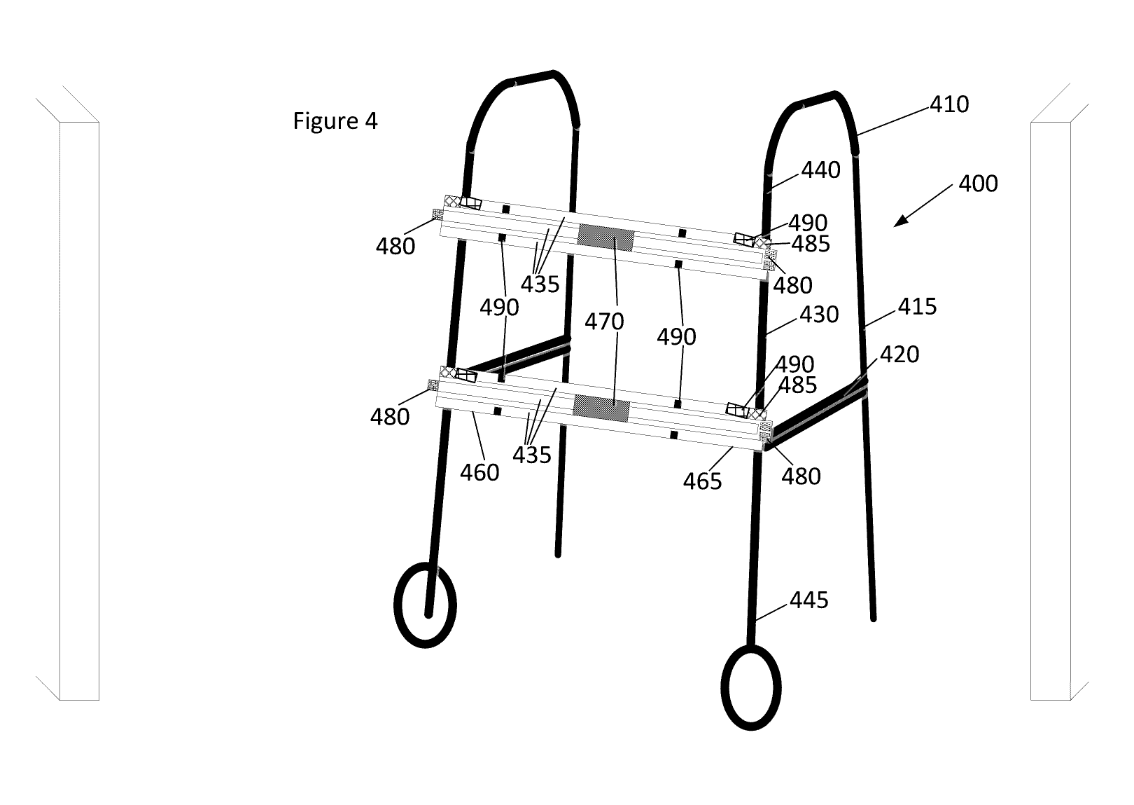

FIG. 4 shows a diagrammatic view of an aspect of a device including a structural frame. A device is provided that includes a structural frame 400 including: a walker 410 having two or more substantially vertically extending base legs 415 and an upright support portion 420 extending vertically upward from the base legs; one or more vertical linear portions 430 operably attached to the walker and substantially parallel to the base legs, each of the one or more vertical linear portions 430 having a first end 440 and a second end 445; and one or more horizontal linear portions 450 operably attached to the walker and substantially perpendicular to the base legs, the one or more horizontal linear portions enclosing one or more first expandable telescoping sections 435 disposed within the horizontal linear portions, wherein each of the one or more horizontal linear portions 450 have a third end 460 and a fourth end 465.

The structural frame 400 may include a force loading mechanism 470 engaging each of the one or more of the first expandable telescoping sections 435, wherein the force loading mechanism 470 is operably connected to expand the one or more of the first expandable telescoping sections 435 and is operably connected to apply outward compressive force 480 at each of the third end 460 and the fourth end 465. The structural frame 400 may include a locking mechanism 490, wherein the one or more first expandable telescoping sections 435 are configured to be secured into place by the locking mechanism 490 during application of the outward compressive force.

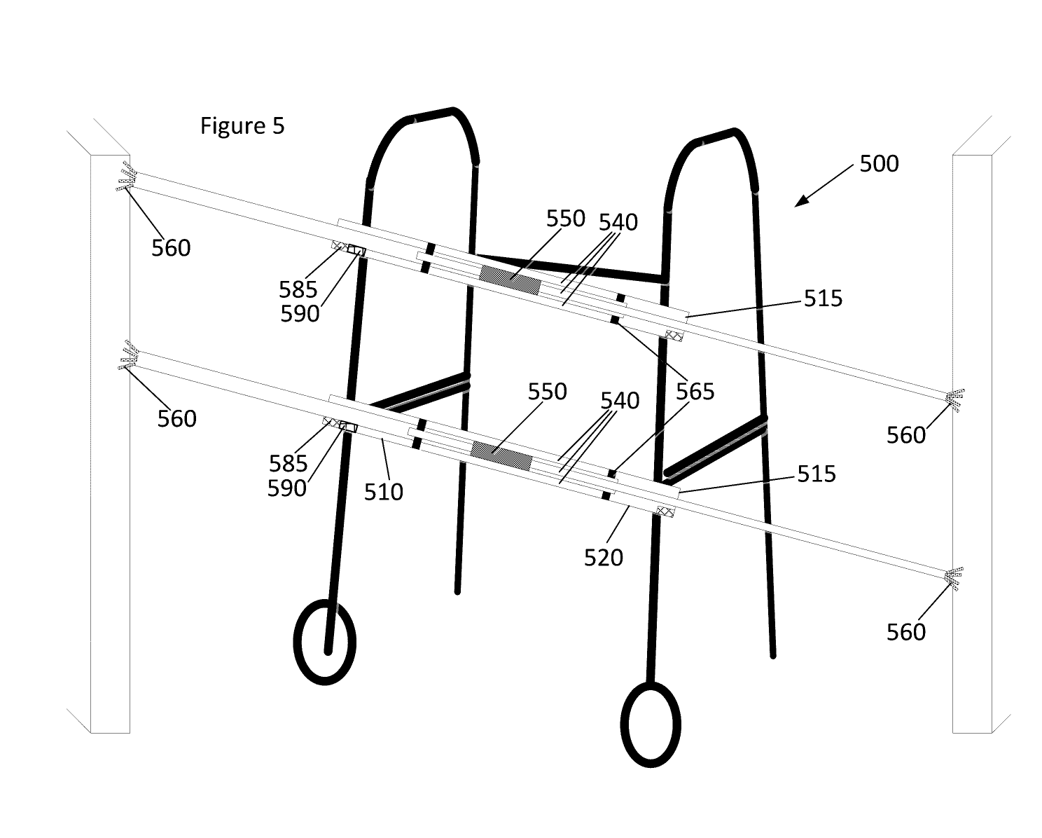

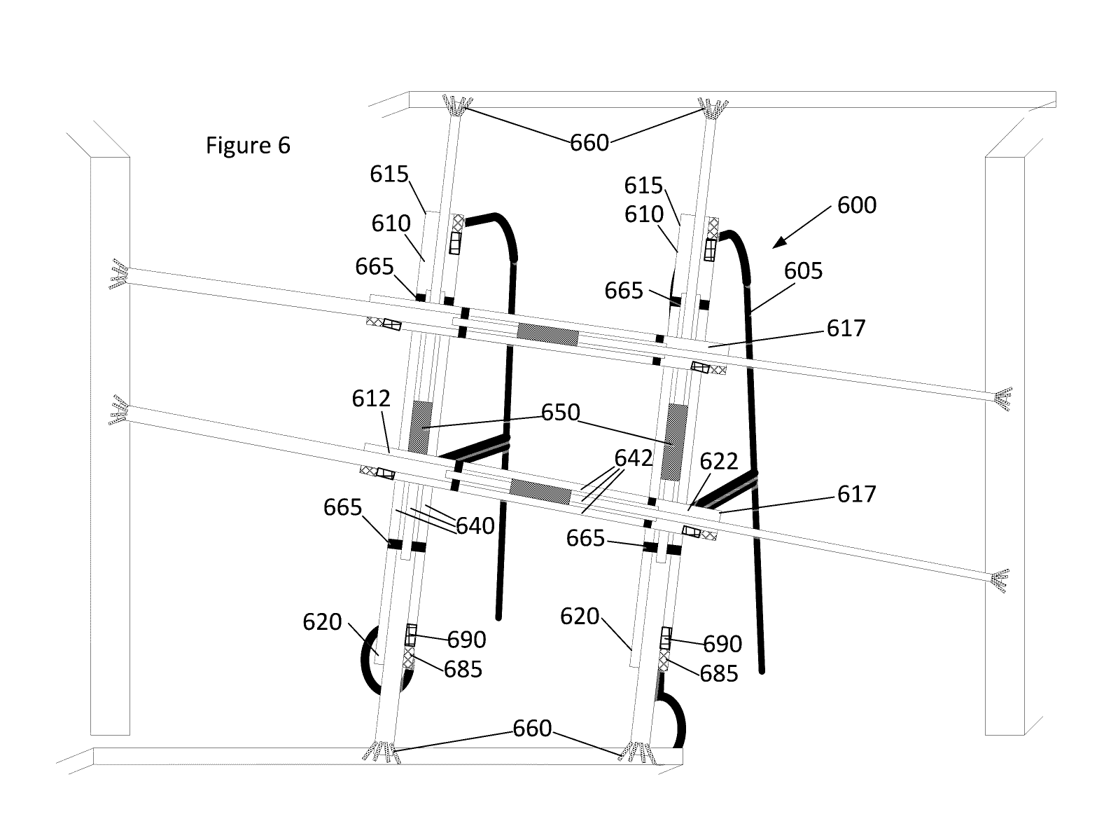

FIG. 5 shows a diagrammatic view of an aspect of a device including a structural frame 500. FIG. 6 shows a diagrammatic view of an aspect of a device including a structural frame 600. A device is provided that includes a structural frame 500 including: a walker having two or more substantially vertically extending base legs and an upright support portion extending vertically upward from the base legs; and one or more horizontal linear portions 515 operably attached to the walker and substantially perpendicular to the base legs, the one or more horizontal linear portions 515 enclosing one or more first expandable telescoping sections 540 disposed within the horizontal linear portions, wherein each of the one or more horizontal linear portions 515 have a first end 510 and a second end 520. A device is provided that includes a structural frame 600 including: a walker 605 having two or more substantially vertically extending base legs and an upright support portion extending vertically upward from the base legs; one or more vertical linear portions 615 operably attached to the walker and substantially parallel to the base legs, each of the one or more vertical linear portions 615 having a first end 610 and a second end 620; and one or more horizontal linear portions 617 operably attached to the walker and substantially perpendicular to the base legs, the one or more horizontal linear portions enclosing one or more first expandable telescoping sections 642 disposed within the horizontal linear portions, wherein each of the one or more horizontal linear portions 617 have a third end 612 and a fourth end 622.

The structural frame 600 may include the one or more vertical linear portions 615 having a third end 610 and a fourth end 620 enclosing one or more second expandable telescoping sections 640 disposed within the vertical linear portions 615. The structural frame 600 may include extendable and retractable load-bearing feet 560, 660 at each of the first end 610 and the second end 620 of the vertical linear portion 615 and at each of the third end 510, 612 and the fourth end 520, 622 of the horizontal linear portion 515, 617, wherein the load-bearing feet 560, 660 are operable to extend upon expansion of the one or more first expandable telescoping sections 640 disposed within the vertical linear portions 615, and the second expandable telescoping sections 540, 642 disposed within the horizontal linear portions 515, 617.

As shown in FIG. 5 and FIG. 6, the one or more vertical poles 615 have the force loading mechanism 650 operably connected to expand the first expandable telescoping sections 640 of the vertical poles 615 in the vertical direction and the one or more horizontal poles 515 having a third end 510 and a fourth end 520. The horizontal poles 515 have the force loading mechanism 550 operably connected to expand the second expandable telescoping sections 540 of the horizontal poles in the horizontal direction. The structural frame may include the one or more vertical poles 615 have the force loading mechanism 650 operably connected to expand the first expandable telescoping sections 640 of the vertical poles inclined from the vertical direction and the one or more horizontal poles 515 have the force loading mechanism 550 operably connected to expand the second expandable telescoping sections 540 of the horizontal poles inclined from the horizontal direction. The one or more horizontal linear portions 515 may enclose one second expandable telescoping sections 540 disposed within the horizontal linear portions 515, and expandable in one dimension 510. The one or more horizontal linear portions 515 may enclose two second expandable telescoping sections 540 disposed within the horizontal linear portions, and expandable in two dimensions 510, 520.

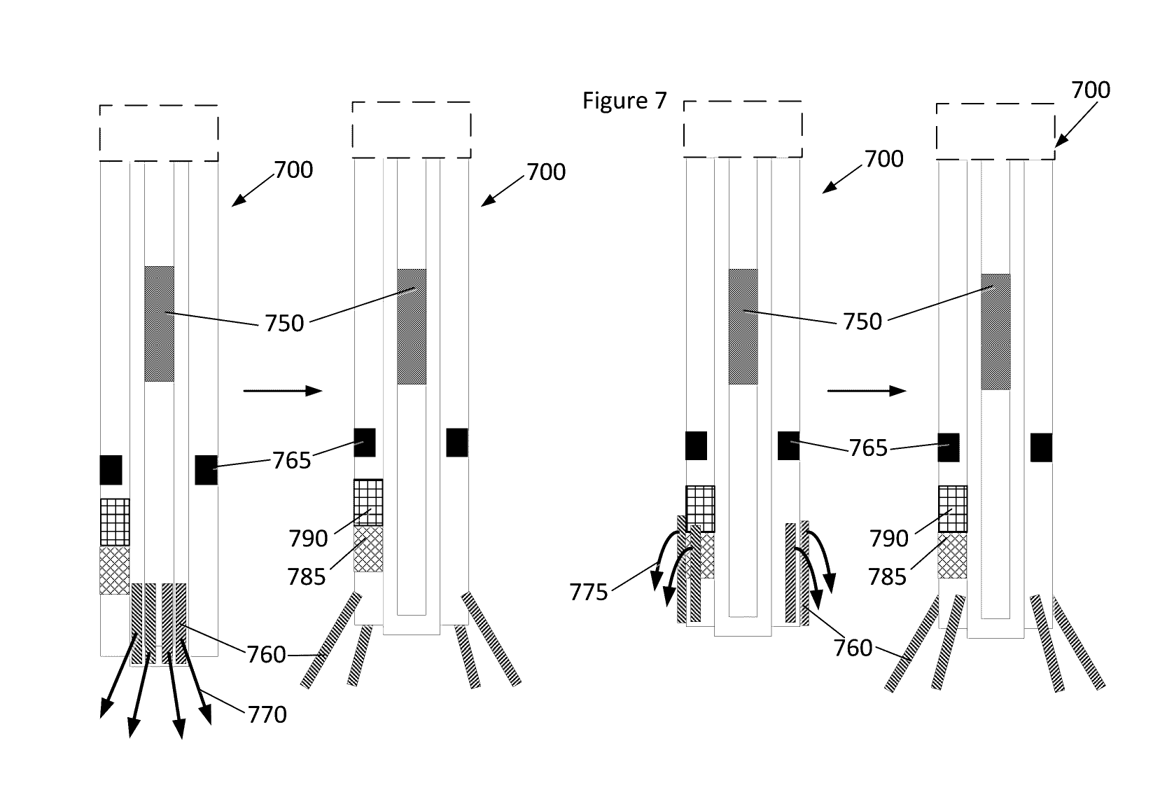

FIG. 7 shows a diagrammatic view of an aspect of a device including a structural frame. The structural frame 700 includes the sensor 785 in communication with a controller 790 to monitor lateral load bearing or slippage at the force loading mechanism 750 and to increase anchor force 760 of the linear rod in response to the lateral load bearing or the slippage. The structural frame 700 may be configured to increase the anchor force from the force loading mechanism 750 by increasing suction, increasing hook and loop attachment force, or increasing gecko type suction force at the extendable and retractable load-bearing feet 760. In some aspects, the extendable and retractable load-bearing feet 760 may be configured to be repositioned 770. The extendable and retractable load-bearing feet 760 are configured to be extended into place 770 or flipped into place 775.

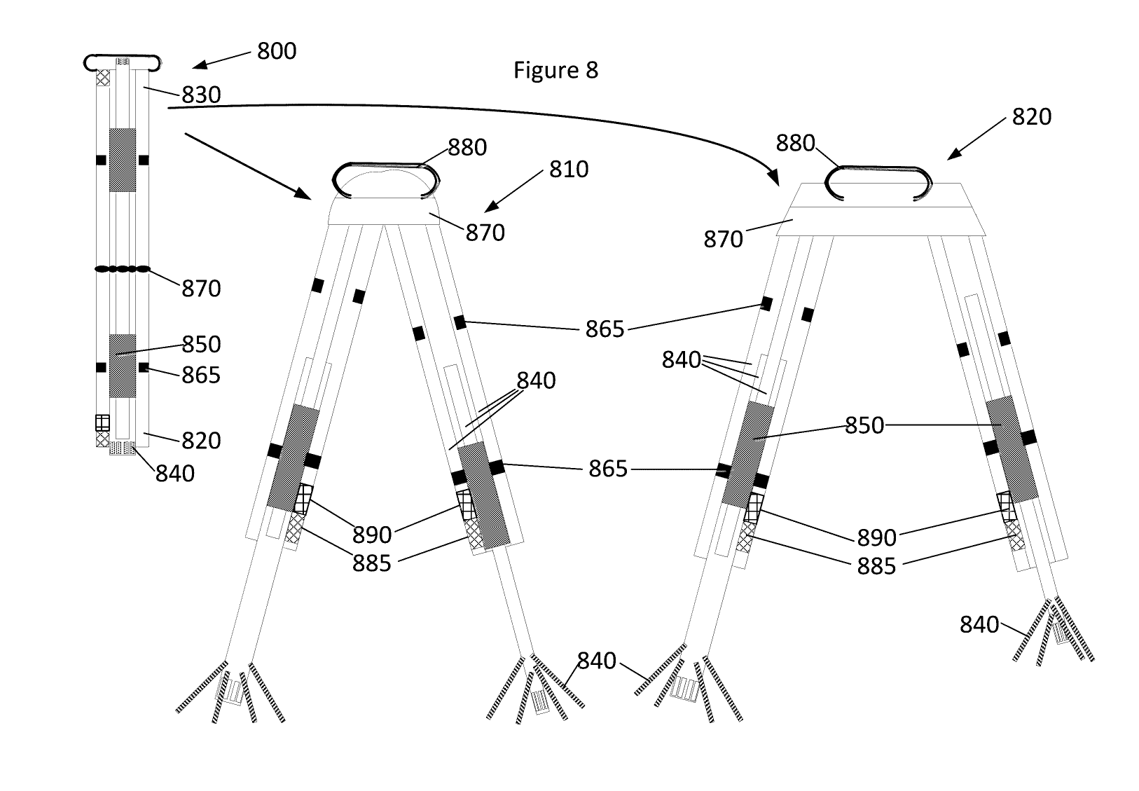

FIG. 8 shows a diagrammatic view of an aspect of a device including a structural frame. A device is provided that includes a structural frame 800 comprising: a linear rod 805 having a first end 820 and a second end 830, load-bearing feet 840 attached at one of the first end 820 and the second end 830 of the linear rod; a controllable force-application mechanism 850 operably connected to the load-bearing feet, the controllable force-application mechanism configured to activate the load-bearing feet 840 to facilitate secure and reversible attachment of the load-bearing feet to a horizontal or vertical surface of a structure proximal to the first end 820 or the second end 830 of the linear rod, and the controllable force-application mechanism configured to activate the load-bearing feet 840 to facilitate secure and reversible disconnection of the load-bearing feet 840 from the surface substantially parallel to an axis of the linear rod 810. The structural frame may 800 include the linear rod 805 that is separable 870 into two or more segments to form a V-shaped structure 810 or a U-shaped structure 820 having load-bearing feet 840 attached at the first end and the second end of the linear rod.

The structural frame 800 may include a pump 860 attached to the structural frame, wherein the controllable force-application mechanism 850 is configured to increase an attachment force by increasing suction at the load-bearing feet 840. The structural frame may include an extendable and retractable handle grip 380 attached at least one of the first end and the second end of the linear rod. The structural frame may include a sensor 885 in communication with a controller 890 to monitor lateral load bearing or slippage and to increase attachment force of the linear rod in response to the lateral load bearing or the slippage. The controllable force-application mechanism 850 may be configured to increase the attachment force by increasing suction at the extendable and retractable load-bearing feet. The controllable force-application mechanism 850 may be configured to increase the attachment force by driving a spike 840 from the extendable and retractable load-bearing feet into a wall.

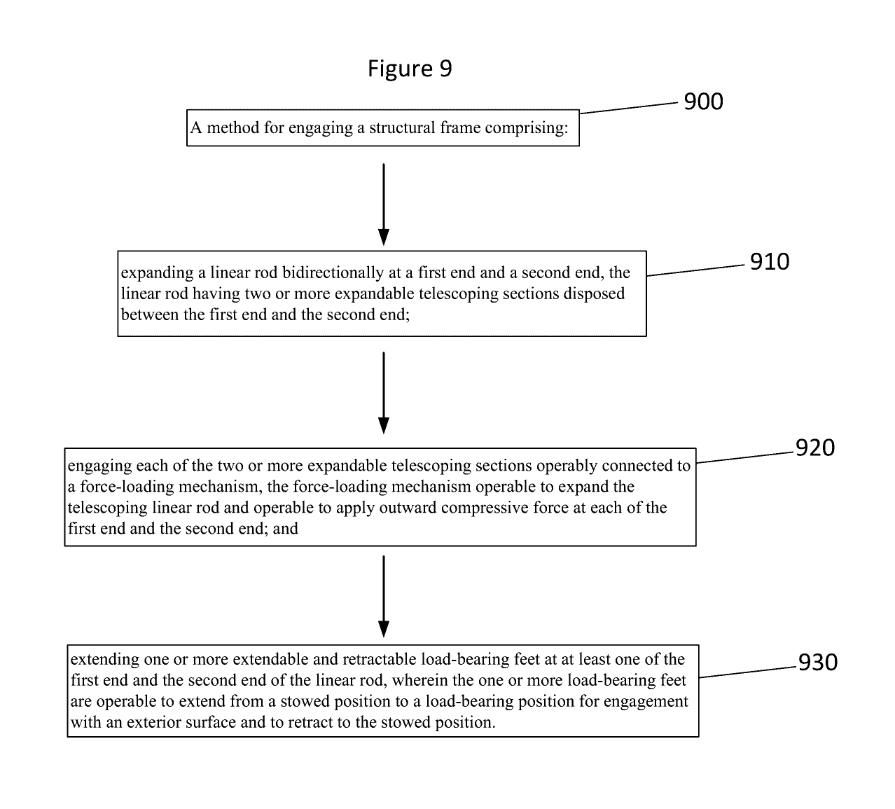

FIG. 9 shows a diagrammatic view of an aspect of a method 900 for engaging a structural frame comprising: expanding 910 a linear rod bidirectionally at a first end and a second end, the linear rod having two or more expandable telescoping sections disposed between the first end and the second end; engaging 920 each of the two or more expandable telescoping sections operably connected to a force-loading mechanism, the force-loading mechanism operable to expand the telescoping linear rod and operable to apply outward compressive force at each of the first end and the second end; and extending 930 one or more extendable and retractable load-bearing feet at at least one of the first end and the second end of the linear rod, wherein the one or more load-bearing feet are operable to extend from a stowed position to a load-bearing position for engagement with an exterior surface and to retract to the stowed position.

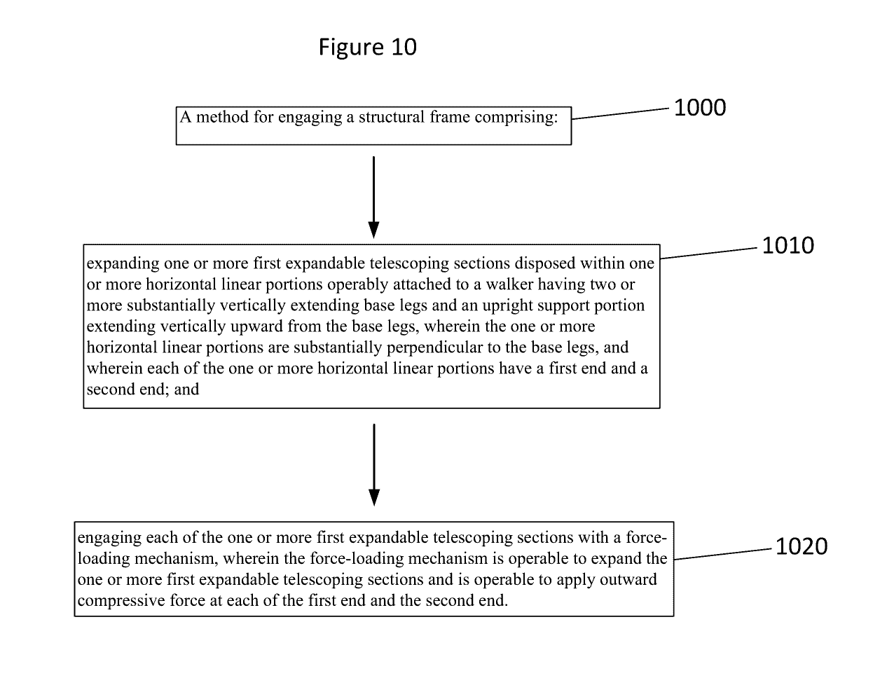

FIG. 10 shows a diagrammatic view of an aspect of a method 1000 for engaging a structural frame comprising: expanding 1010 one or more first expandable telescoping sections disposed within one or more horizontal linear portions operably attached to a walker having two or more substantially vertically extending base legs and an upright support portion extending vertically upward from the base legs, wherein the one or more horizontal linear portions are substantially perpendicular to the base legs, and wherein each of the one or more horizontal linear portions have a first end and a second end; and engaging 1020 each of the one or more first expandable telescoping sections with a force-loading mechanism, wherein the force-loading mechanism is operable to expand the one or more first expandable telescoping sections and is operable to apply outward compressive force at each of the first end and the second end.

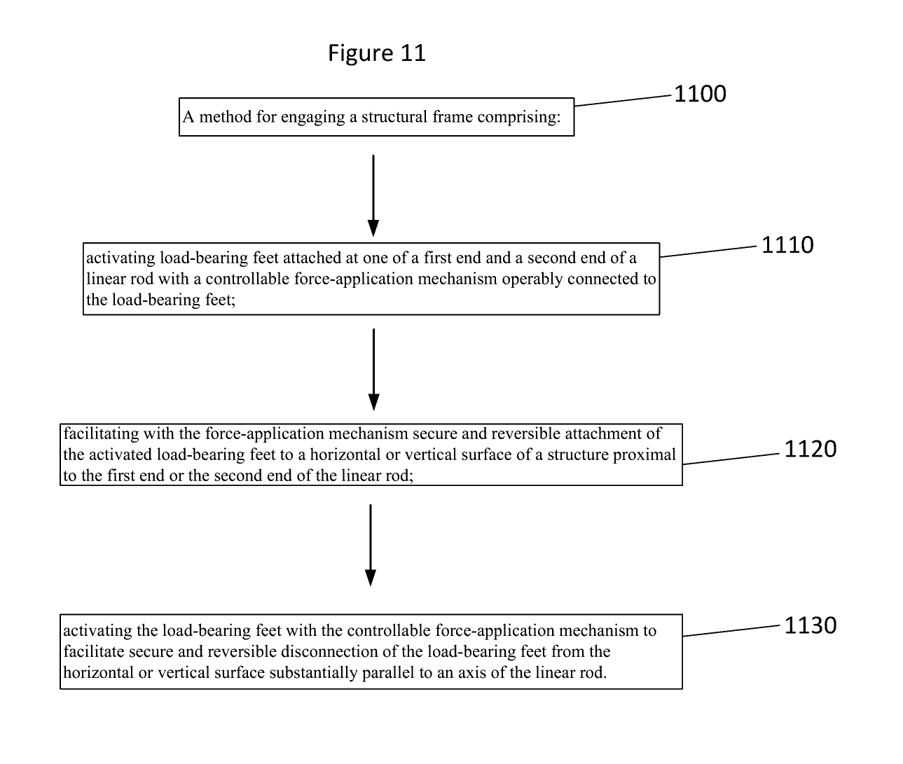

FIG. 11 shows a diagrammatic view of an aspect of a method 1100 for engaging a structural frame comprising: activating 1100 load-bearing feet attached at one of a first end and a second end of a linear rod with a controllable force-application mechanism operably connected to the load-bearing feet; facilitating 1110 with the force-application mechanism secure and reversible attachment of the activated load-bearing feet to a horizontal or vertical surface of a structure proximal to the first end or the second end of the linear rod; and activating 1120 the load-bearing feet with the controllable force-application mechanism to facilitate secure and reversible disconnection of the load-bearing feet from the horizontal or vertical surface substantially parallel to an axis of the linear rod.

### A Structural Frame Including Two or More Expandable Telescoping Sections

A structural frame including a linear rod having a first end and a second end and two or more expandable telescoping sections disposed between the first end and the second end of the linear rod wherein the two or more expandable telescoping sections are operable to expand the linear rod bidirectionally at the first end and the second end is designed to include a locking gas spring to facilitate the immediate and safe adjustability, i.e., either the lengthening or shortening of the structural frame by the user at any given time. The structural frame includes two or more expandable telescoping sections.

The slidable, telescoping relative movement of the two or more expandable telescoping sections may be controlled by the gas spring housed within at least a portion of both the two or more expandable telescoping sections. The gas spring generally includes a gas cylinder, a piston and a piston rod. The gas cylinder is situated in one of the two or more expandable telescoping sections. The piston rod portion of the gas spring is affixed at a second of the two or more expandable telescoping sections with the opposing end of the piston rod attached within the piston and is generally freely slidable within the gas cylinder. This arrangement of the gas cylinder and piston in the two or more expandable telescoping sections is important with regards to the functional aspects and other structural features of the structural frame in that it provides a safe and easy to operate device.

The structural frame may include a locking gas spring. A gas spring includes; a gas cylinder, a piston contained within the cylinder, a piston rod connected to the piston, and a seal between the edge of the piston and the cylinder wall. The structural frame may include a locking gas spring. The locking gas spring includes a hole or valve located in the piston to allow the pressure on both sides of the piston to equalize as the piston is compressed into the cylinder. The valve through the piston is controllable via a valve control device to attain an open position allowing an equalization of the pressure on both sides of the piston within the cylinder as the piston is compressed, and a closed position where such equalization is not permitted. Understanding basic gas theory where force is equal to a pressure multiplied over an area (F=P×A), where there is a larger area defined by the face side of the piston and the pressures P₁ and P₂ are the same because of the open valve, a higher force F₂ will be generated to act on the face side of the piston. The magnitude of the higher force F₂ is dependent upon the pressure level inside the cylinder, the cross-sectional area of the cylinder and piston, and the cross-sectional area of the piston rod. See, e.g., U.S. Pat. No. 7,882,847, which is incorporated herein by reference.

### A Structural Frame Including Two or More Expandable Telescoping Sections Having a Cam Locking Assembly

The structural frame including two or more expandable telescoping sections includes a cam locking assembly located adjacent the open end of at least one of the two or more expandable telescoping sections. The cam locking assembly includes a housing, cam member, and an actuating lever, integrally formed with the cam member. The housing is a hollow, generally cylindrical conformation adapted for receipt over the end of the first tubular member. The housing may be circumferentially continuous at opposite ends and may include a mounting boss extending outwardly from the sidewall. A cavity is formed in the boss to receive the cam member therein. The cavity has a pair of spaced recesses that receive similarly dimensioned shoulders of the cam member. Moreover, the cavity communicates with a cutout or notch in the boss through which the actuating lever of the cam member extends. The actuating lever has a pivotal range of movement of approximately ninety degrees, abutting contact with the housing and the recess wall defining stop surfaces that limit further travel of the lever. In some aspects, an enlarged tab is formed on the lever at an end opposite to the cam member to facilitate actuation by a user. See, e.g., U.S. Pat. No. 5,775,352, which is incorporated herein by reference.

### A Structural Frame Including a Force-Loading Mechanism Having a Motorized Extension Pole to Engage Each of the Two or More Expandable Telescoping Sections

The structural frame may include a force-loading mechanism engaging each of the two or more expandable telescoping sections operably connected to expand the telescoping linear rod and operably connected to apply outward compressive force at each of the first end and the second end. The force-loading mechanism may include a motorized extension pole between the two or more expandable telescoping sections. The two or more expandable telescoping sections are telescopically movable between retracted and extended positions with respect to the first pole member.

A battery powered, variable speed drive motor is secured to an end of two or more expandable telescoping sections with the drive motor being selectively reversible. The drive motor includes a rotatable driven member. An elongated externally threaded screw or bolt member, having first and second ends, has its first end thereof coupled to the driven member for rotation therewith in a first direction and a second direction opposite to the first direction. The screw member is threadably coupled to at least one of the two or more expandable telescoping sections whereby rotation of the screw member in the first direction by the drive motor causes the two or more expandable telescoping sections to move from its retracted position towards its extended position. The rotation of the screw member in the second direction by the drive motor causes the two or more expandable telescoping sections to move from its extended position towards its retracted position. The extension pole may include a structure that prevents the two or more expandable telescoping sections from rotating with respect to one another, as the expandable telescoping sections move between its retracted and extended positions. See, e.g., U.S. 2014/0033549, which is incorporated herein by reference.

### A Structural Frame Including a Distance Measuring Sensor

The structural frame may include a distance measuring sensor unit to detect distances between 10 and 150 cm from the structural frame to a wall, floor, or potential obstacle. The sensor may be used as a proximity sensor. The distance measuring sensor unit or proximity sensor is composed of an integrated combination of PSD (position sensitive detector), IR-LED (infrared emitting diode) and signal processing circuit. The variation of reflectivity of the target object, the environmental temperature and the operating duration of the sensor do not affect a determination by a triangulation method of the distance from the sensor to the target object. The device outputs the voltage corresponding to the detection distance. See, e.g., Distance Measuring Sensor Unit [SHARP], which is incorporated herein by reference.

### PROPHETIC EXEMPLARY EMBODIMENTS

### Prophetic Example 1

### A Structural Frame Including a Telescoping Cane to Assist Patients at Risk of Falling

A structural frame that includes a cane can extend and wedge between opposing walls or counters to assist a patient who has lost their balance or fallen. The cane is a structural frame composed of a linear rod having feet at both ends of the linear rod that can adhere to walls, counters via suction, Velcro® hook and loop type fastener, gecko microsuction feet). The cane has power source to apply outward force through a force-loading mechanism on the linear rod to extend telescoping sections of the linear rod to walls or floors and to lock into place. Extension is controlled by sensor/controller components that ensure the extended cane wedges firmly between walls or floor. Sensor/controller components also detect side slippage of the feet and increase their anchoring force as needed. Once the extended cane is firmly wedged between walls then patient can grasp the cane to maintain balance or to pull up to a sitting or standing position.

A telescoping cane including the linear rod with anchoring feet at each end is constructed with gas cylinders as the force-loading mechanism to extend the telescoping segments of the linear rod and to extend the anchoring feet into the walls on either side. Sensors on the cane will detect the walls and signal a controller that will stop extension of the linear rod after engaging the walls. The cane is constructed from aluminum with telescoping segments at each end that are capped with anchor feet. The anchor feet adhere by suction to walls, floors and other flat surfaces. The cane also has a standard foot at the bottom end for walking A handle is attached at the top end of the cane for walking, i.e., without the anchor feet extended. Two hydraulic gas cylinder units are the force-loading mechanism installed within the linear rod to extend the telescoping segments and to apply forces to securely wedge the cane between two walls. For example, each hydraulic gas cylinder unit may include: a gas cylinder, a piston within the cylinder, a piston rod connected to the piston and a seal between the cylinder wall and the piston. Gas cylinder units and telescoping tubes are under hydraulic controls. See e.g., U.S. Pat. No. 7,882,847 issued to Coe on Feb. 8, 2011, which is incorporated herein by reference. The piston rods are each connected to one end of their respective extending segments of the telescopic linear rod. A cylinder of compressed gas, e.g., carbon dioxide or air is connected to the gas cylinder units to pressurize the pistons when extending the linear rod of the cane. Electronically actuated pneumatic valves to control gas flow from the cylinders are available from AIRTEC Pneumatics Inc., Addison, Ill. Moreover, the extended linear rod may be locked into a stable extended position by a locking mechanism that prevents the cane segments from extending or retracting; for example, by mechanical and gas pressure locking mechanisms. See e.g., U.S. Pat. No. 5,775,352 issued to Obitts on Jul. 7, 1998 and U.S. Pat. No. 7,882,847 Ibid. which are incorporated herein by reference.

An impact sensor is placed on the linear rod of the cane to detect contact of the extending telescopic segments with flat surfaces. For example, when an expandable cane segment strikes a wall, the impact sensor signals to a controller, which in turn stops extension of the cane segment and maintains a preset level of force on the extended telescopic segments. Electronic impact sensors to monitor the extension of the telescoping segments are available from PHD Inc., Fort Wayne, Ind. The anchor feet at the termini of the extended telescopic segments are suction cups that are connected to a vacuum source and controlled by a controller receiving signals from a position sensor on the cane. Distance measuring sensors with a range of 10 cm to 150 cm are available from Digi-Key, Thief River Falls, Minn. See e.g., Position Sensor Infosheet which is incorporated herein by reference. Sideways movement, e.g., slippage of the anchor feet on a flat surface, or tilting of the linear rod from vertical are detected by the position sensor and signaled to the controller which may actuate the vacuum source and strengthen the interaction force between the suction cups and the walls. Suction cups, vacuum generators (e.g., compact pneumatic ejectors), and vacuum switches are available from Schmalz Inc., Raleigh, N.C. See e.g., the Vacuum Components Catalog available online at http://catalog.schmalz.com/, which is incorporated herein by reference.

The telescoping cane may be used as a regular walking aid with the handle and walking tip providing support and stability unless more support is needed. If the user becomes unbalanced, trips or falls the cane may be extended instantly by pressing a button on the handle of the cane. If a bridge between two walls is required the cane is brought horizontal before extension to make a bridge perpendicular to the walls. If a stumble occurs the user may simply activate the extendable cane to create a vertical floor to ceiling brace. Alternatively, the telescoping cane may respond to voice commands such as “Extend” from the user when a fall or stumble occurs.

### Prophetic Example 2

A Structural Frame Including a Walker with Extendable Braces to Provide Emergency Support

A structural frame that includes a walker may provide support in the event of a fall or loss of balance by a subject. The walker is constructed to include braces that extend and support the walker horizontally between two walls or vertically between the floor and the ceiling or between other surrounding surfaces. The walker incorporates telescoping rods having a force loading mechanism that is motorized and that applies extension forces horizontally or vertically to nearby walls, or to the ceiling and floor. The horizontal linear portions of the telescoping rods are capped at each end by anchor feet. The anchor feet are suction pads that attach to the walls, floor, or ceiling to prevent slippage horizontal linear portions of the telescoping rods in the support brace of the walker. Deployment of the telescoping rods in the support braces is mediated by a controller that receives signals from the individual using the walker and/or from sensors on the walker. The sensor in communication with the controller may monitor lateral load bearing or slippage and respond by increasing attachment force of the linear telescoping rods in response to the lateral load bearing or the slippage.

The walker is constructed from extruded aluminum with telescoping horizontal and vertical support braces nested inside the tubular aluminum frame. A force loading mechanism engages each of the expandable telescoping sections of the horizontal and vertical support braces to brace against the surrounding walls or the surrounding floor and ceiling. The expandable telescoping sections are telescopic hollow rods that have suction pads at their ends to secure to the walls, floor, and ceiling. The expandable telescoping sections are incorporated in the walker that also has standard feet, crossbars and vertical frame posts, e.g., see FIGS. 4, 5 and 6. See e.g., U.S. Pat. No. 7,373,942 issued to Yeager on May 20, 2008, which is incorporated herein by reference. Telescoping support braces of the expandable telescoping sections are constructed as multiple tube segments of fractionally smaller diameters, e.g., successively decreasing by ⅛ inch that slide within one another. Hollow telescoping braces will support the weight of an adult person. See e.g., U.S. Pat. No. 8,286,281 issued to Toothman on Oct. 16, 2012, which is incorporated herein by reference. The walker is constructed with 4 collapsible/telescoping braces that are enclosed within the extruded aluminum frame of the walker. For example, collapsible/telescoping braces are installed within two horizontal crossbars of the walker with one brace extending to the right and one brace extending to the left or with both braces extending in both directions. See, e.g., FIGS. 4 and 5. In addition, two vertical telescoping braces, each comprised of 4 nested segments of approximately 36 inches in length are installed within the front two vertical frame posts of the walker. The frame posts are open ended to allow the telescoping braces to extend to the floor and ceiling. See, e.g., FIG. 6.

A force loading mechanism engaging each of the one or more of the first expandable telescoping sections include battery powered variable speed drive motors that are connected to each telescoping brace and drive the telescoping brace to extend the support brace and apply an outward force to the nearest wall or flat surface. See e.g., U.S. Patent Appl. No. 2014/0033549 by Ramsey et al published on Feb. 6, 2014 and U.S. Pat. No. 4,924,573 issued to Huddleston, deceased et al. on May 15, 1990 which are incorporated herein by reference. Moreover the telescoping braces contain a locking mechanism that prevents the brace from retracting and thus maintains an extension force on the adjacent wall or flat surface. See, e.g., U.S. Pat. No. 5,775,352 issued to Obitts on Jul. 7, 1998 and U.S. Pat. No. 7,882,847 Ibid. which are incorporated herein by reference. An impact sensor is placed on the telescoping braces to detect contact of the extending telescopic segments with flat surfaces. Electronic impact sensors to monitor the extension of the telescoping segments are available from PHD Inc., Fort Wayne, Ind. For example, when an extending brace segment strikes a wall, the impact sensor signals to the controller, which in turn stops extension of the brace, maintains a preset level of extending force and actuates the locking mechanism. If the impact sensor or position sensor detects slippage of the telescoping brace, the sensor signals to the controller to increase extension of the brace and to increase force.

The walker including the telescoping braces is capped by suction pads that anchor the braces to the floor, walls, and ceiling. Sideways movement of the vertical braces, e.g., slippage of the anchor feet on a flat surface, or tilting of the vertical braces may be detected by a position sensor. Distance measuring sensors with a range of 10 cm to 150 cm are available from Digi-Key, Thief River Falls, Minn. See e.g., Position Sensor Infosheet, which is incorporated herein by reference. Anchor foot movement or support brace tipping are signaled to the controller which actuates a vacuum source linked to the slipping suction pad, and strengthens the interaction force, i.e., vacuum, between the suction pad and the flat surface. Suction pads, vacuum generators e.g., compact pneumatic ejectors, and vacuum switches are available from Schmalz Inc., Raleigh, N.C. See e.g., the Vacuum Components Catalog available online at http://catalog.schmalz.com/ which is incorporated herein by reference.

### Prophetic Example 3

A Structural Frame Including a Jointed Walking Stick or Cane with Extending and Jointed Support Braces

A structural frame that includes a walking cane or walking stick is constructed from a jointed linear rod with expandable telescoping segments, a joint in the middle and anchor feet to secure the stick to the floor or adjacent walls and provide support to the user. The walking stick contains expandable telescoping segments and anchor feet that are gecko microsuction pads or Velcro® hook and loop pads. The telescoping segments and anchor feet stabilize adherence to flat surfaces and carpeting, respectively. Controls in the handle of the walking stick control deployment of the telescoping segments and the anchor feet. Sensors on the walking stick detect the positions of the anchor feet and the extended segments.

The walking stick is manufactured from aluminum with two telescoping segments attached via a pivot joint to the top of the stick where a handle is attached. A standard rubber tip or pad on the bottom of the stick may be used as a standard walking support with the extendable legs in a folded or collapsed position. See, e.g., FIG. 3. For additional stability or to prevent a fall, the anchor feet may be deployed by the user when the user presses a button on the handle of the stick. For example, anchor feet made with industrial strength Velcro® hook and loop fasteners (available from Velcro USA Inc., Manchester, N.H.) may be deployed to adhere to carpeting or specially designed “hook and loop” fabric. Velcro® hook and loop feet may be extended by a force-loading mechanism that is a spring mechanism to extend the feet to the rug or carpet on the floor. See, e.g., FIG. 3. Alternatively, for flat surfaces such as hardwood floors, the anchor feet may be suction pads that are connected to a force-loading mechanism that is a vacuum generator located within the extendable legs. A push button control in the handle deploys the suction pad and activates the vacuum source. See, e.g., FIG. 3. Suction pads, vacuum generators, e.g., compact pneumatic ejectors, and vacuum switches are available from Schmalz Inc., Raleigh, N.C. See e.g., the Vacuum Components Catalog available online at http://catalog.schmalz.com/ which is incorporated herein by reference. A position sensor on the walking stick monitors the location of the anchor feet and the tilt angle of the walking stick to detect slippage of the anchor feet or leaning or falling of the extended segments. Distance measuring sensors with a range of 10 cm to 150 cm are available from Digi-Key, Thief River Falls, Minn. See e.g., Position Sensor Infosheet, which is incorporated herein by reference. If slippage or tipping is detected at the position sensor, the position sensor signals to a central controller on the walking stick to increase the adherence force of the anchor feet. For example, additional Velcro feet may be deployed or the vacuum force on the suction pads may be increased.

The extendable segments on the walking stick are attached by a pivot at the top of the walking stick that allows them to pivot or radiate out from a closed or collapsed position. For example a user may push a button on the walking stick to rotate the extendable segments out at approximately a 60 degree angle to provide a broad base of support and an extended handle to hold. See, e.g., FIGS. 2 and 3. Pivots and hinges are used to adjust the extendable and retractable load bearing feet of the cane supports. See e.g., U.S. Pat. No. 4,962,781 issued to Kanbar on Oct. 16, 1990 which is incorporated herein by reference. Alternatively the user may rotate the extendable segments approximately 90 degrees to a horizontal position. The user may activate the force-loading mechanism to extend the segments and to wedge the walking stick between two walls. Activation of the expandable telescoping sections also deploys the anchor feet, e.g., suction pads to adhere to the walls. The force-loading mechanism includes motor springs that are used to provide rotation and extension forces on the expandable telescoping sections. Telescoping poles may extend by rotation and may be motor driven. See e.g., U.S. Patent Appl. No. 2014/0033549 by Ramsey et al published on Feb. 6, 2014 and U.S. Pat. No. 4,924,573 issued to Huddleston, on May 15, 1990, which are incorporated herein by reference. For example motor springs are available from KERN-LIEBERS USA INC., Spiroflex Division, Holland, Ohio. See e.g., the Infosheet: SpiroflexMotorSprings which is incorporated herein by reference. The motor spring may be rewound manually to reset the spring. Extension of one or more telescoping sections and engagement of anchor feet with the floor or a wall is detected by an impact sensor mounted on the walking stick. The impact sensor signals to the controller to activate a locking mechanism that maintains the extension force on the floor or wall. See e.g., U.S. Pat. No. 5,775,352 issued to Obitts on Jul. 7, 1998 which is incorporated herein by reference. Electronic impact sensors to monitor the extension of the telescoping segments are available from PHD Inc., Fort Wayne, Ind. Following deployment of the walking stick by the user, i.e., rotation and extension of the telescoping sections, activating the anchor feet and locking the segments in place, the user may grab the handle to regain their balance or to stand up if they have fallen. To resume walking, the user may release the extension force, anchor feet and locking mechanism by pushing a button on the handle. This action signals a controller to release the vacuum on the suction pads and unlock the extended segments, allowing the segments to retract and rotate to a collapsed position.

### Prophetic Example 4

A Structural Frame Including a Walking Stick with Activatable Anchor Feet

A structural frame that includes a walking cane or a walking stick is constructed from a linear rod with anchor feet to secure the stick to the floor or adjacent walls and provide support to the user. The walking stick may optionally have expandable telescoping segments to extend the anchor feet to a secure surface, such as a wall or floor. The walking stick contains anchor feet that are gecko microsuction pads or Velcro® hook and loop pads. The anchor feet stabilize adherence to flat surfaces and carpeting, respectively. Controls in the handle of the walking stick control deployment of the anchor feet. Sensors on the walking stick detect the positions of the anchor feet.

The walking stick is manufactured from aluminum with optionally with two expandable telescoping segments. A standard rubber tip or pad on the bottom of the stick may be used as a standard walking support with the extendable legs in a folded or collapsed position. See, e.g., FIG. 7. For stability or to prevent a fall, the anchor feet may be deployed by the user who presses a button on the handle of the stick. For example, anchor feet made with industrial strength Velcro® hook and loop fasteners (available from Velcro USA Inc., Manchester, N.H.) may be deployed to adhere to carpeting or specially designed “hook and loop” fabric. Velcro® hook and loop feet may be extended by a force-loading mechanism that is a spring mechanism to extend the feet to the rug or carpet on the floor. See, e.g., FIG. 3. Alternatively, for flat surfaces such as hardwood floors, the anchor feet may be suction pads that are connected to a force-loading mechanism that is a vacuum generator located within the extendable legs. A push button control in the handle deploys the suction pad and activates the vacuum source. See, e.g., FIG. 3. Suction pads, vacuum generators, e.g., compact pneumatic ejectors, and vacuum switches are available from Schmalz Inc., Raleigh, N.C. (see e.g., the Vacuum Components Catalog available online at http://catalog.schmalz.com/ which is incorporated herein by reference). A position sensor on the walking stick monitors the location of the anchor feet and the tilt angle of the walking stick to detect slippage of the anchor feet or leaning or falling of the extended segments. Distance measuring sensors with a range of 10 cm to 150 cm are available from Digi-Key, Thief River Falls, Minn. See e.g., Position Sensor Infosheet, which is incorporated herein by reference. If slippage or tipping is detected at the position sensor, the position sensor signals to a central controller on the walking stick to activate the force-application mechanism to increase the adherence force of the anchor feet. For example, additional Velcro feet may be deployed or the vacuum force on the suction pads may be increased.

The extendable segments on the walking stick are attached by a pivot at the top of the walking stick that allows them to pivot or radiate out from a closed or collapsed position. For example a user may push a button on the walking stick to rotate the extendable segments out at approximately a 60 degree angle to provide a broad base of support and an extended handle to hold. See, e.g., FIGS. 2 and 3. Pivots and hinges are used to adjust the extendable and retractable load bearing feet of the cane supports. See e.g., U.S. Pat. No. 4,962,781 issued to Kanbar on Oct. 16, 1990 which is incorporated herein by reference. Alternatively the user may rotate the extendable segments approximately 90 degrees to a horizontal position. The user may activate the force-loading mechanism to extend the segments and to wedge the walking stick between two walls. Activation of the expandable telescoping sections also deploys the anchor feet, e.g., suction pads to adhere to the walls. The force-loading mechanism includes motor springs that are used to provide rotation and extension forces on the expandable telescoping sections. Telescoping poles may extend by rotation and may be motor driven. See e.g., U.S. Patent Appl. No. 2014/0033549 by Ramsey et al published on Feb. 6, 2014 and U.S. Pat. No. 4,924,573 issued to Huddleston, on May 15, 1990, which are incorporated herein by reference. For example motor springs are available from KERN-LIEBERS USA INC., Spiroflex Division, Holland, Ohio. See e.g., the Infosheet: SpiroflexMotorSprings which is incorporated herein by reference. The motor spring may be rewound manually to reset the spring. Extension of one or more telescoping sections and engagement of anchor feet with the floor or a wall is detected by an impact sensor mounted on the walking stick. The impact sensor signals to the controller to activate a locking mechanism that maintains the extension force on the floor or wall. See e.g., U.S. Pat. No. 5,775,352 issued to Obitts on Jul. 7, 1998 which is incorporated herein by reference. Electronic impact sensors to monitor the extension of the telescoping segments are available from PHD Inc., Fort Wayne, Ind. Following deployment of the walking stick by the user, i.e., rotation and extension of the telescoping sections, activating the anchor feet and locking the segments in place, the user may grab the handle to regain their balance or to stand up if they have fallen. To resume walking, the user may release the extension force, anchor feet and locking mechanism by pushing a button on the handle. This action signals a controller to release the vacuum on the suction pads and unlock the extended segments, allowing the segments to retract and rotate to a collapsed position.

Each recited range includes all combinations and sub-combinations of ranges, as well as specific numerals contained therein.

All publications and patent applications cited in this specification are herein incorporated by reference to the extent not inconsistent with the description herein and for all purposes as if each individual publication or patent application were specifically and individually indicated to be incorporated by reference for all purposes.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will recognize that there are various vehicles by which processes and/or systems and/or other technologies disclosed herein can be effected (e.g., hardware, software, and/or firmware), and that the preferred vehicle will vary with the context in which the processes and/or systems and/or other technologies are deployed. For example, if a surgeon determines that speed and accuracy are paramount, the surgeon may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies disclosed herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those having ordinary skill in the art will recognize that optical aspects of implementations will typically employ optically-oriented hardware, software, and or firmware.

In a general sense the various aspects disclosed herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices disclosed herein, or a microdigital processing unit configured by a computer program which at least partially carries out processes and/or devices disclosed herein), electrical circuitry forming a memory device (e.g., forms of random access memory), and/or electrical circuitry forming a communications device (e.g., a modem, communications switch, or optical-electrical equipment). The subject matter disclosed herein may be implemented in an analog or digital fashion or some combination thereof.

In an embodiment, the system and the device are integrated in such a manner that the system operates as a unique system configured specifically for function of the biodegradable optical fiber device or the photodegradable optical fiber device, and any associated computing devices of the system operate as specific use computers for purposes of the claimed system or claimed device, and not general use computers. In an embodiment, at least one associated computing device of the system operates as specific use computers for purposes of the claimed system, and not general use computers. In an embodiment, at least one of the associated computing devices of the system are hardwired with a specific ROM to instruct the at least one computing device. In an embodiment, one of skill in the art recognizes that the biodegradable optical fiber device, the photodegradable optical fiber device, and associated system effect an improvement at least in the technological fields of biomedical therapeutics, biomedical diagnostics, or surgery.

At least a portion of the devices and/or processes described herein can be integrated into a data processing system. A data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

The herein described components (e.g., steps), devices, and objects and the description accompanying them are used as examples for the sake of conceptual clarity and that various configuration modifications using the disclosure provided herein are within the skill of those in the art. Consequently, as used herein, the specific examples set forth and the accompanying description are intended to be representative of their more general classes. In general, use of any specific example herein is also intended to be representative of its class, and the non-inclusion of such specific components (e.g., steps), devices, and objects herein should not be taken as indicating that limitation is desired.

With respect to the use of substantially any plural or singular terms herein, the reader can translate from the plural to the singular or from the singular to the plural as is appropriate to the context or application. The various singular/plural permutations are not expressly set forth herein for sake of clarity.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable or physically interacting components or wirelessly interactable or wirelessly interacting components or logically interacting or logically interactable components.

While particular aspects of the present subject matter described herein have been shown and described, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an”; the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, or A, B, and C together, etc.). Virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A structural frame comprising:
a linear rod having a first end and a second end;
two or more expandable telescoping sections disposed between the first end and the second end of the linear rod wherein the two or more expandable telescoping sections are operable to expand the linear rod bidirectionally at the first end and the second end;
a force-loading mechanism operably connected to each of the two or more expandable telescoping sections operable to apply outward compressive force at each of the first end and the second end of the linear rod; and
one or more extendable and retractable load-bearing feet at at least one of the first end and the second end of the linear rod, wherein the one or more load-bearing feet are operable to extend from a stowed position to a load-bearing position for engagement with an exterior surface and to retract to the stowed position.

2.-5. (canceled)

6. The structural frame of claim 1, comprising a locking mechanism, wherein the two or more expandable telescoping sections of the linear rod are configured to be secured into place by the locking mechanism during application of the outward compressive force.

7.-11. (canceled)

12. The structural frame of claim 1, comprising a sensor in communication with a controller to determine a size of an opening span in a vicinity of the structural frame and to control extension of the two or more expandable telescoping sections to the size of the opening span.

13. The structural frame of claim 1, comprising a sensor in communication with a controller to determine a presence of an opening span in a vicinity of the structural frame and to control extension of at least one of the one or more extendable and retractable load-bearing feet.

14.-15. (canceled)

16. The structural frame of claim 1, comprising a sensor in communication with a controller to determine a loss of contact of at least one of the one or more extendable and retractable load-bearing feet with a surface and to control retraction of the one or more extendable and retractable load-bearing feet.

17. The structural frame of claim 1, comprising a sensor in communication with a controller to monitor lateral load bearing or slippage and to increase anchor force of the linear rod in response to the lateral load bearing or the slippage.

18.-20. (canceled)

21. The structural frame of claim 17, comprising a pump attached to the structural frame, wherein the pump is configured to increase the anchor force by increasing suction at the one or more extendable and retractable load-bearing feet.

22.-40. (canceled)

41. A structural frame comprising:
a walker having two or more substantially vertically extending base legs and an upright support portion extending vertically upward from the base legs;
one or more vertical linear portions operably attached to the walker and substantially parallel to the base legs, each of the one or more vertical linear portions having a first end and a second end;
one or more horizontal linear portions operably attached to the walker and substantially perpendicular to the base legs, the one or more horizontal linear portions enclosing one or more first expandable telescoping sections disposed within the horizontal linear portions, wherein each of the one or more horizontal linear portions have a third end and a fourth end; and
a first force loading mechanism engaging each of the one or more of the first expandable telescoping sections, wherein the first force loading mechanism is operably connected to expand the one or more of the first expandable telescoping sections and is operably connected to apply outward compressive force at each of the third end and the fourth end.

42. The structural frame of claim 41, comprising:
one or more second expandable telescoping sections disposed within the vertical linear portions; and
a second force loading mechanism engaging each of the one or more of the second expandable telescoping sections, wherein the second force loading mechanism is operably connected to expand the one or more of the second expandable telescoping sections and is operably connected to apply outward compressive force at each of the first end and the second end.

43. The structural frame of claim 42, comprising:
extendable and retractable load-bearing feet at the first end and the second end of the vertical linear portion and at the third end and the fourth end of the horizontal linear portion, wherein the load-bearing feet are operable to extend upon expansion of the one or more first expandable telescoping sections and the one or more second expandable telescoping sections.

44. The structural frame of claim 42, wherein the one or more vertical linear portions have the second force loading mechanism operably connected to expand the one or more second expandable telescoping sections of the vertical linear portions in a vertical direction and the one or more horizontal linear portions have the first force loading mechanism operably connected to expand the one or more first expandable telescoping sections of the horizontal linear portions in a horizontal direction.

45. The structural frame of claim 42, wherein the one or more vertical linear portions have the second force loading mechanism operably connected to expand the one or more second expandable telescoping sections of the vertical linear portions inclined from a vertical direction and the one or more horizontal linear portions have the first force loading mechanism operably connected to expand the one or more first expandable telescoping sections of the horizontal linear portions inclined from a horizontal direction.

46. The structural frame of claim 41, wherein the first force-loading mechanism is a spring loading mechanism.

47. The structural frame of claim 41, wherein the first force-loading mechanism is a hydraulic loading mechanism.

48. The structural frame of claim 41, wherein the first force-loading mechanism is a motor.

49. The structural frame of claim 41, wherein the first force-loading mechanism is configured to be manually applied by a user.

50. The structural frame of claim 41, comprising a locking mechanism, wherein the one or more first expandable telescoping sections are configured to be secured into place by the locking mechanism during application of the outward compressive force.

51. The structural frame of claim 41, wherein the one or more horizontal linear portions enclose one first expandable telescoping section disposed within the horizontal linear portions, and expandable in one dimension.

52. The structural frame of claim 41, wherein the one or more horizontal linear portions enclose two first expandable telescoping sections is disposed within the horizontal linear portions, and expandable in two dimensions.

53. The structural frame of claim 41, comprising a sensor in communication with a controller to determine a size of an opening span in a vicinity of the structural frame and to control extension of the one or more first expandable telescoping sections to the size of the opening span.

54. The structural frame of claim 43, comprising a sensor in communication with a controller to determine a presence of an opening span in a vicinity of the structural frame and to control extension of at least one of the load-bearing feet.

55. The structural frame of claim 54, wherein the controller is configured to control the extension based on proximity of at least one of the first end or the second end of the one or more vertical linear portions or the third end or the fourth end of the one or more horizontal linear portions to a surface of the opening span.

56. The structural frame of claim 54, wherein the controller is configured to control the extension based on an orientation of at least one of the one or more of the vertical linear portions or the one or more of the horizontal linear portions relative to the opening span.

57. The structural frame of claim 43, comprising a sensor in communication with a controller to determine a loss of contact of at least one of the load-bearing feet with a surface and to control retraction of the load-bearing feet.

58. The structural frame of claim 43, comprising a sensor in communication with a controller to monitor lateral load bearing or slippage and to increase anchor force of at least one of the one or more of the vertical linear portions and the one or more of the horizontal linear portions in response to the lateral load bearing or the slippage.

59. The structural frame of claim 58, wherein the structural frame is configured to increase the anchor force by increasing suction at the extendable and retractable load-bearing feet.

60. The structural frame of claim 58, wherein the structural frame is configured to increase the anchor force by driving a spike from the extendable and retractable load-bearing feet into an exterior surface.

61. The structural frame of claim 58, wherein the structural frame is configured to increase the anchor force by increasing the outward compressive force.

62. The structural frame of claim 58, comprising a pump attached to the structural frame, wherein the pump is configured to increase the anchor force by increasing suction at the extendable and retractable load-bearing feet.

63. The structural frame of claim 58, comprising a gecko microsuction force surface integrated at the extendable and retractable load-bearing feet, wherein the structural frame is configured to increase the anchor force by increasing gecko microsuction force at the extendable and retractable load-bearing feet.

64.-81. (canceled)

82. A structural frame comprising:
a linear rod having a first end and a second end;
load-bearing feet attached at one of the first end and the second end of the linear rod; and
a controllable force-application mechanism operably connected to the load-bearing feet, the controllable force-application mechanism configured to activate the load-bearing feet to facilitate secure and reversible attachment of the load-bearing feet to a horizontal or vertical surface of a structure proximal to the first end or the second end of the linear rod, and the controllable force-application mechanism configured to activate the load-bearing feet to facilitate secure and reversible disconnection of the load-bearing feet from the horizontal or vertical surface substantially parallel to an axis of the linear rod.

83. The structural frame of claim 82, comprising a pump attached to the structural frame, wherein the controllable force-application mechanism is configured to increase an attachment force by increasing suction at the load-bearing feet.

84. The structural frame of claim 82, comprising a gecko microsuction force surface integrated at the load-bearing feet, wherein the controllable force-application mechanism is configured to increase an attachment force by increasing contact of the gecko microsuction force surface with the horizontal or vertical surface of the structure proximal to the first end or the second end of the linear rod.

85. The structural frame of claim 84, wherein the controllable force-application mechanism is configured to increase contact of the gecko microsuction force surface by changing a location of the gecko microsuction force surface within the load-bearing feet.

86. The structural frame of claim 82, comprising a hook and loop type fastener surface integrated at the load-bearing feet, wherein the controllable force-application mechanism is configured to increase an attachment force by increasing contact of the hook and loop type fastener surface with the horizontal or vertical surface of the structure proximal to the first end or the second end of the linear rod.

87. The structural frame of claim 86, wherein the controllable force-application mechanism is configured to increase contact of the hook and loop type fastener surface by changing the location of the hook and loop type fastener surface within the load-bearing feet.

88. The structural frame of claim 82, comprising an extendable and retractable handle grip attached at at least one of the first end and the second end of the linear rod.

89. The structural frame of claim 82, wherein the linear rod is separable into two or more segments to form a V-shaped structure or a U-shaped structure having load-bearing feet attached at the first end and the second end of the linear rod.

90. The structural frame of claim 82, comprising a sensor in communication with a controller to monitor lateral load bearing or slippage and to increase an attachment force of the linear rod in response to the lateral load bearing or the slippage.

91. The structural frame of claim 90, wherein the controllable force-application mechanism is configured to increase the attachment force by increasing suction at the load-bearing feet.

92. The structural frame of claim 90, wherein the controllable force-application mechanism is configured to increase the attachment force by driving a spike from the load-bearing feet into an exterior surface.

93.-103. (canceled)

104. The method of claim 42, wherein the second force loading mechanism is at least one of a spring loading mechanism, a hydraulic loading mechanism, or a motor.

105. The method of claim 42, wherein the second force loading mechanism is configured to be manually applied by a user.
